(19) United States
(12) Patent Application Publication
(10) Pub. No.: US 2016/0188815 A1
(43) Pub. Date: Jun. 30, 2016

(54) MEDICAL SUPPORT APPARATUS, SYSTEM AND METHOD FOR MEDICAL SERVICE

(71) Applicant: FUJIFILM Corporation, Tokyo (JP)

(72) Inventors: Yuya KUDO, Tokyo (JP); Satoshi UEDA, Tokyo (JP); Hironori MATSUMASA, Tokyo (JP); Ryosuke USAMI, Tokyo (JP); Takamasa YAGUCHI, Tokyo (JP); Yasunori OHTA, Tokyo (JP)

(73) Assignee: FUJIFILM Corporation, Tokyo (JP)

(21) Appl. No.: 14/976,469

(22) Filed: Dec. 21, 2015

(30) Foreign Application Priority Data
Dec. 26, 2014 (JP) 2014-265151

(51) Int. Cl. G06F 19/00; G06F 3/0485

(52) U.S. Cl. CPC G06F 19/327; G06F 3/0485

(57) ABSTRACT

A medical support apparatus for outputting information of a medical service for a patient body includes an input receiving device for receiving medical care information input by user input in relation to the patient body. A page generator generates a medical support page containing first and second display areas arranged with one another. The first display area displays a medical care schedule with plural medical services arranged in a time sequence to be performed for the patient body. The second display area displays and arranges the medical care information in a sequence of reception in the input receiving device while the medical services are performed. Preferably, the medical care information includes message information for communication between medical staff members. The medical care information is entered and displayed according to instant messaging in a multi-user environment in a medical team.

### CROSS-REFERENCE TO RELATED APPLICATION

This application claims priority under 35 USC 119 from Japanese Patent Application No. 2014-265151, filed 26 Dec. 2014, the disclosure of which is incorporated by reference herein.

### BACKGROUND OF THE INVENTION

1. Field of the Invention

The present invention relates to a medical support apparatus, system and method for a medical service. More particularly, the present invention relates to a medical support apparatus, system and method for a medical service, in which medical services can be performed in a suitable manner according to a medical care schedule (patient workflow).

2. Description Related to the Prior Art

Medical computer systems of various types are suggested in the medical field for supporting medical care. For example, JP-A 2014-063214 discloses a medical support system for receiving inputs of symptoms or the like of a patient body, and for automatically creating and displaying a medical care schedule (patient workflow) for the medical care. The medical care schedule is constituted by plural medical services arranged in a time sequence for the patient body. Examples of the medical services are patient care, examination, diagnosis, treatment, surgery, preparation for the patient care, and the like. In the medical care schedule, time and a sequence of performing the medical services are determined. Creating the medical care schedule makes it possible to share information of the medical care schedule between staff members of the hospital facility, inclusive of a doctor, nurses and other caregivers.

However, it is medically necessary to refer to a larger amount of medical care information related to the medical care schedule in addition to the medical care schedule disclosed in the above-indicated patent document for the purpose of sufficient medical support. For example, the entirety of the medical care information in a medical history in the progress of the medical services should be reviewed in addition to a suggested sequence of medical services in the medical care schedule, for example, messages between medical staff members of a medical team and results of diagnosis. However, JP-A 2014-063214 is silent on collecting such medical care information, although creation of a medical care schedule is facilitated by use of the disclosure. Collection of the medical care information may require much laborious operation.

### SUMMARY OF THE INVENTION

In view of the foregoing problems, an object of the present invention is to provide a medical support apparatus, system and method for a medical service, in which medical services of plural members of a medical team can be performed in a suitable manner according to a medical care schedule (patient workflow).

In order to achieve the above and other objects and advantages of this invention, a medical support apparatus for outputting information of a medical service for a patient body includes an input receiving device for receiving medical care information input by user input in relation to the patient body. A page generator generates a medical support page containing first and second display areas arranged with one another, the first display area displaying a medical care schedule with plural medical services arranged in a time sequence to be performed for the patient body, the second display area displaying and arranging the medical care information in a sequence of reception in the input receiving device while the medical services are performed.

Preferably, the medical care information includes message information for communication between medical staff members.

Preferably, the medical care information includes a diagnostic result of the patient body.

Preferably, the first display area displays a timeline representation, and an indicator, disposed with the timeline representation, for indicating a date or time of receiving the medical care information.

Preferably, a display form of the indicator is changeable according to a type of the medical care information.

Preferably, upon receiving plural items of the medical care information at one time, the indicator of which a number corresponds to a number of the items of the medical care information is displayed.

Preferably, the first display area displays a timeline representation with a changeable display size.

Preferably, the medical care information includes patient health information and message information, the indicator is constituted by first and second indicators, the first indicator is set for the patient health information, and the second indicator is set for the message information and different from the patient health information in a display form.

Preferably, in case a predetermined input action for scroll is performed, the medical care schedule in the first display area is scrolled in a direction of the time sequence in the medical support page.

Preferably, in case a predetermined input action for scroll is performed, the medical care information in the second display area is scrolled in a direction of the sequence of the reception in the medical support page.

Preferably, the page generator further performs display processing of an input field adapted to input the medical care information by user input. A send button portion is operated by user input, for sending the medical care information input in the input field.

Preferably, the medical care schedule is scrollable in the medical support page, and partially displayed in the first display area. The plural medical services include first and second medical services, the first medical service and the indicator thereof are displayed in the first display area, and the second medical service is excluded from the first display area and undisplayed. The page generator further performs display processing of an indicator area, displayed along an edge of the first display area, for displaying a second indicator associated with the second medical service.

Also, a medical support system is provided, including a client terminal apparatus, and a medical support apparatus for outputting information of a medical service for a patient body according to a request input by the client terminal apparatus. The medical support apparatus includes an input receiving device for receiving medical care information input by user input in relation to the patient body. A page generator generates a medical support page containing first and second display areas arranged with one another, the first display area displaying a medical care schedule with plural medical services arranged in a time sequence to be performed for the patient body, the second display area displaying and arranging the medical care information in a sequence of reception in the input receiving device while the medical services are performed.

Preferably, the input receiving device receives the medical care information from the client terminal apparatus, and the page generator outputs the medical support page to the client terminal apparatus.

Also, a medical support method for outputting information of a medical service for a patient body is provided, and includes a step of receiving medical care information input by user input in relation to the patient body. A medical support page containing first and second display areas arranged with one another is generated, the first display area displaying a medical care schedule with plural medical services arranged in a time sequence to be performed for the patient body, the second display area displaying and arranging the medical care information in a sequence of reception while the medical services are performed.

Consequently, medical services can be performed in a suitable manner according to a medical care schedule, because medical care information is displayed and arranged in a sequence of reception while the medical services are performed.

### BRIEF DESCRIPTION OF THE DRAWINGS

The above objects and advantages of the present invention will become more apparent from the following detailed description when read in connection with the accompanying drawings, in which:

FIG. 1 is a block diagram schematically illustrating a medical support system;

FIG. 2 is a data chart illustrating an electronic chart database;

FIG. 3 is a data chart illustrating an image database;

FIG. 4 is a data chart illustrating a schedule database;

FIG. 5 is a front elevation illustrating a medical care schedule;

FIG. 6 is a front elevation illustrating medical care information;

FIG. 7 is a block diagram schematically illustrating circuit devices in a medical support server apparatus or other computers;

FIG. 8 is a block diagram schematically illustrating a client terminal apparatus;

FIG. 9 is a front elevation illustrating a medical support page;

FIG. 10 is a front elevation illustrating an entry page;

FIG. 11 is a block diagram schematically illustrating the medical support server apparatus;

FIG. 12 is a flow chart illustrating steps of information distribution and updating of the medical support page;

FIGS. 13, 14, 15 and 16 are front elevations illustrating the medical support page in the course of adding message information;

FIG. 17A is a front elevation illustrating another preferred embodiment having an indicator area for indicators of invisible medical services;

FIGS. 17B and 17C are front elevations illustrating the same as FIG. 17A but after scroll.

### DETAILED DESCRIPTION OF THE PREFERRED EMBODIMENT(S) OF THE PRESENT INVENTION

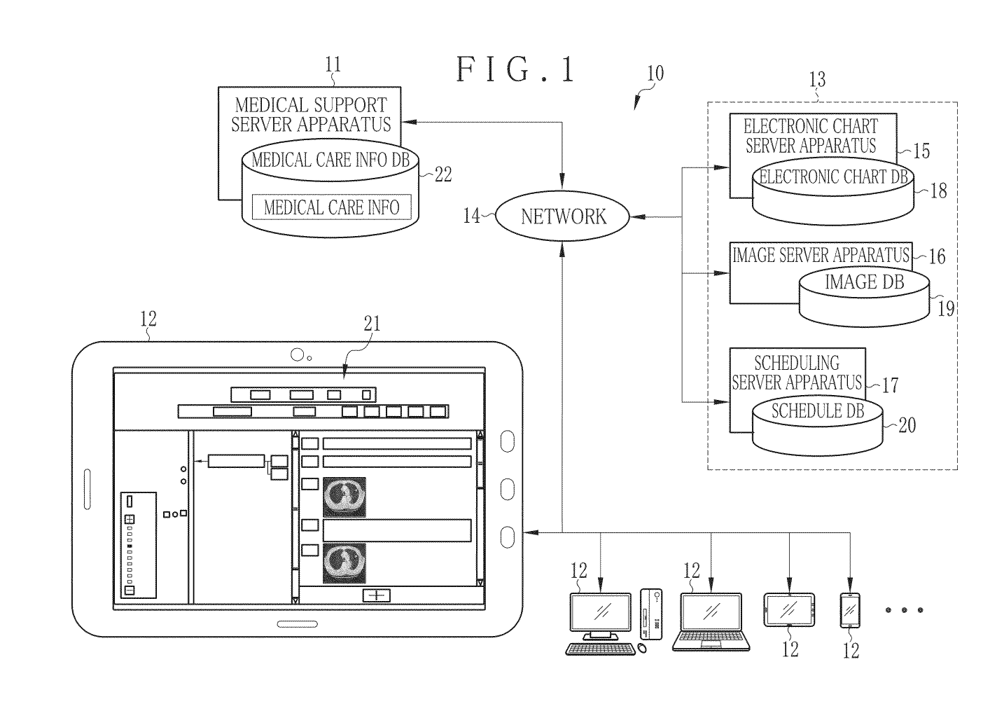

In FIG. 1, a medical support system 10 is a computer system for supporting medical services performed in a hospital facility, such as a clinic, hospital and the like. The medical support system 10 includes a medical support server apparatus 11 as medical support apparatus, a client terminal apparatus 12 and a server cluster 13. A network 14 interconnects those apparatuses communicably. An example of the network 14 is a LAN or local area network installed in the hospital facility.

The server cluster 13 includes an electronic chart server apparatus 15, an image server apparatus 16 and a scheduling server apparatus 17. An electronic chart database 18 or electronic chart DB is combined with the electronic chart server apparatus 15. The image server apparatus 16 is a PACS server according to the PACS or Picture Archiving and Communication System. An image database 19 or image DB is combined with the image server apparatus 16. A schedule database 20 or schedule DB is combined with the scheduling server apparatus 17. Each of the electronic chart database 18, the image database 19 and the schedule database 20 is a database in which search is possible with such a query as a case ID or case identification data of a patient body.

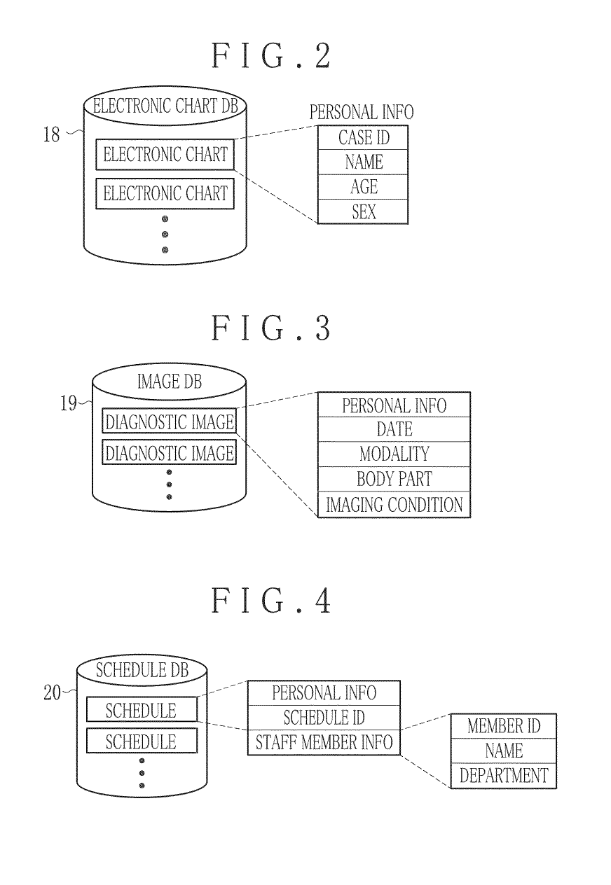

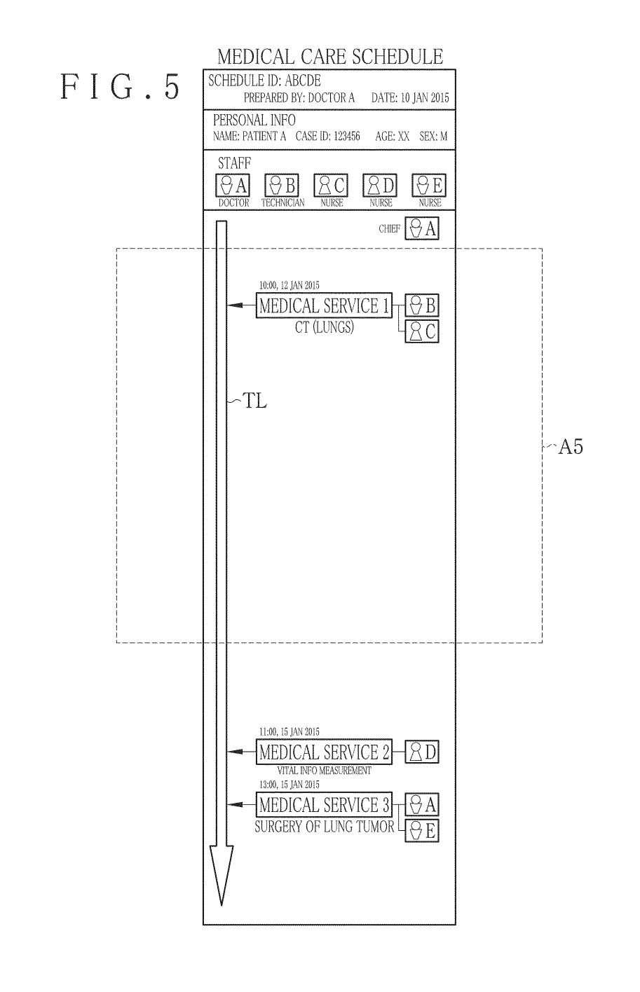

In FIG. 2, plural electronic charts (as patient health information) are stored in the electronic chart database 18. The electronic charts are produced in association with patient bodies. Each of the electronic charts has personal information, which includes the patient's name, case ID, age and sex. In FIG. 3, the image database 19 stores diagnostic images (as patient health information) formed by medical imaging, such as X-ray imaging and CT (computed tomography). Various data are associated with the diagnostic images, such as the personal information of the patient, date of imaging, modality, body part, imaging condition and the like.

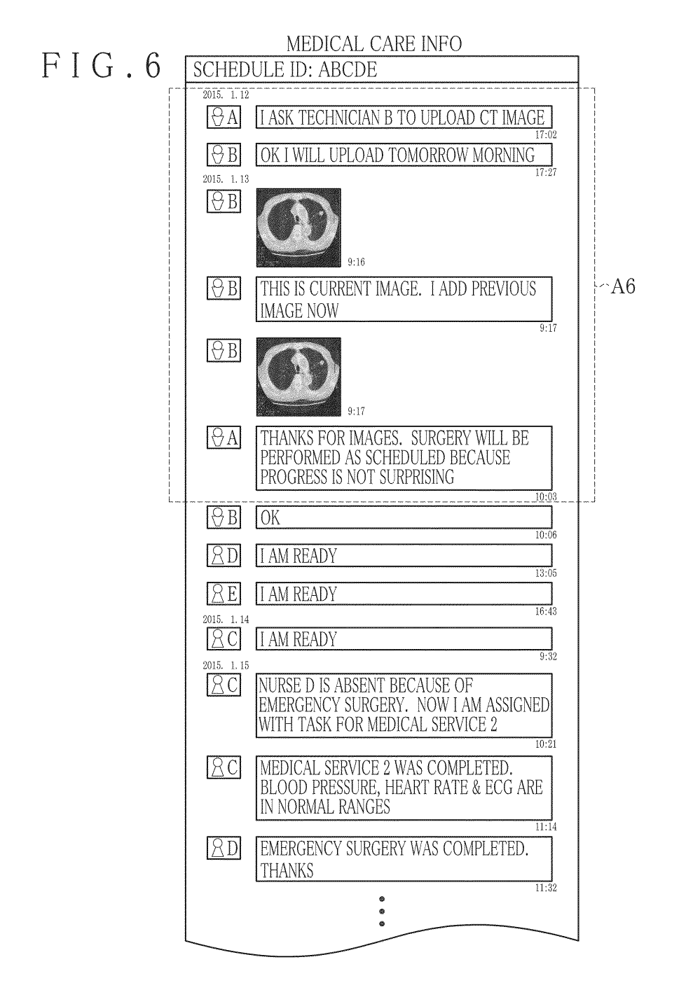

In FIG. 4, plural medical care schedules are stored in the schedule database 20. The medical care schedules are associated with respectively the patient bodies. Various data are additionally combined with the medical care schedules, including personal information, schedule ID, staff member information and the like. The schedule ID is assigned upon generating the medical care schedule, and used for identifying the medical care schedule. The staff member information includes a hospital department, medical staff members (caregivers), member ID, and the like.

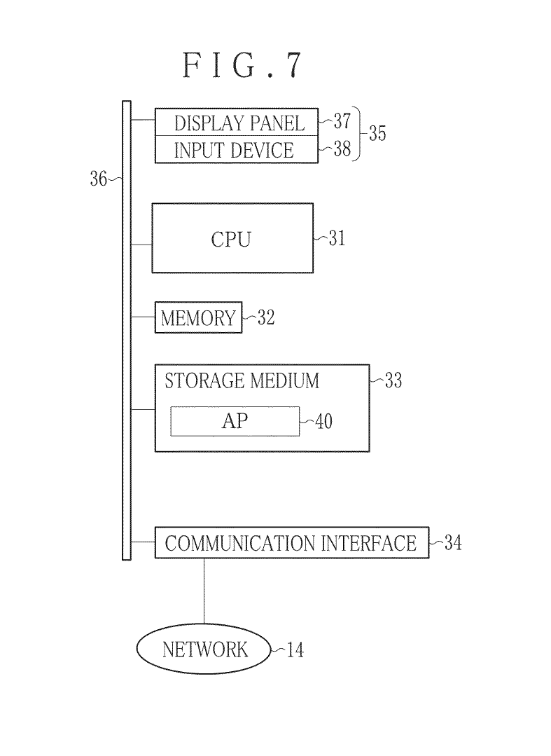

In FIG. 5, a medical care schedule is constituted by arranging plural medical services for the patient body along a timeline TL. An example of the medical care schedule is for surgical operation of excision of a lung tumor in a patient body A. The medical care schedule includes a medical service 1 (CT imaging of lungs as an initial examination), medical service 2 (vital information measurement as a preparatory examination) and medical service 3 (surgical operation of excision of the lung tumor). The medical service 1 is scheduled at 10:00 on 12 Jan. 2015. The medical service 2 is scheduled at 11:00 on 15 Jan. 2015. The surgical operation is scheduled at 13:00 on 15 Jan. 2015 or two hours after the medical service 2.

The staff members of a medical team in relation to the medical care schedule are five, namely a doctor A or medical staff member, a technician B (radiologist), and nurses C, D and E. A chief of the staff members is the doctor A. A task for the medical service 1 is assigned to the technician B and nurse C. A task for the medical service 2 is assigned to the nurse D. A task for the medical service 3 is assigned to the doctor A and nurse E. An initial symptom in the case for the medical care schedule is a lung tumor in the patient body A discovered as a result of CT imaging of lungs in the course of health check-up or screening. The medical care schedule is originally prepared by the doctor A on 10 Jan. 2015. The schedule ID allocated to the medical care schedule is “ABCDE”.

In FIG. 1, examples of the client terminal apparatus 12 are a desktop computer, notebook computer, tablet terminal, smart phone and the like. The client terminal apparatus 12 is used by one doctor or operator as a staff member in a hospital department, such as internal medicine, surgery, otolaryngology and ophthalmology. The client terminal apparatus 12 performs access to the electronic chart server apparatus 15, to produce an electronic chart or view the electronic chart. Also, the client terminal apparatus 12 performs access to the image server apparatus 16 to view a diagnostic image. The client terminal apparatus 12 performs access to the scheduling server apparatus 17 to create and view a medical care schedule.

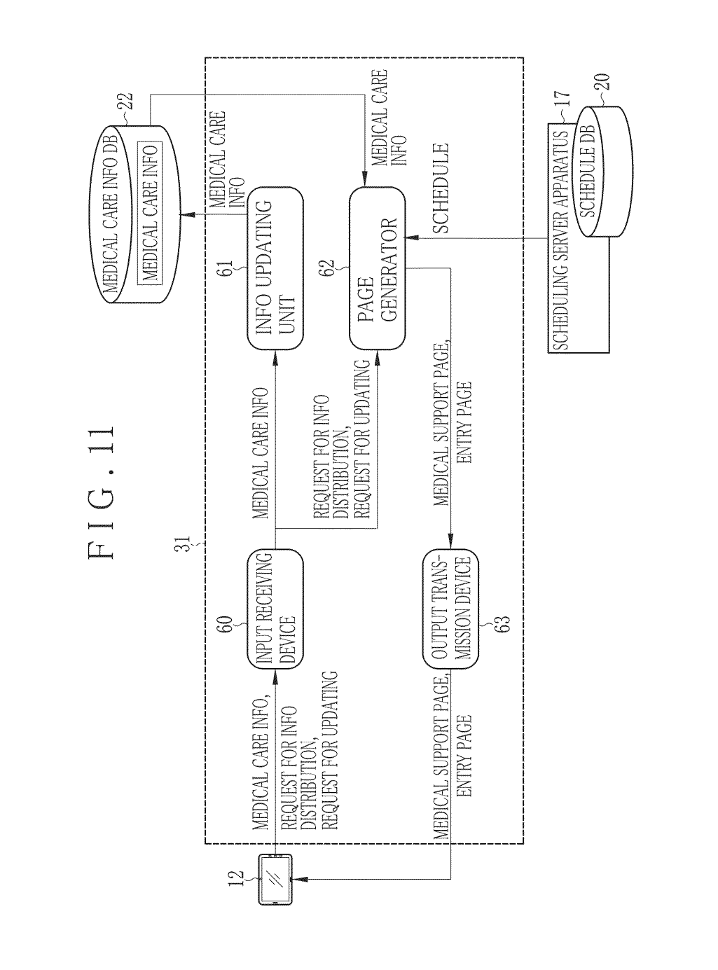

Also, the client terminal apparatus 12 performs access to the medical support server apparatus 11, to view a medical support page 21 of FIG. 9, and input command signals. The medical support page 21 includes a schedule area A1 and an information display area A2 (medical care information area). The schedule area A1 displays a medical care schedule. The information display area A2 displays medical care information entered by user input of a staff member in arrangement of a sequence of the entry. The schedule area A1 is a first display area of the present invention. An input receiving device 60 or input processor to be described later receives the medical care information, which is arranged in the information display area A2 in the sequence of reception (entry). In short, the information display area A2 is a second display area of the present invention, because the medical care information is arranged sequentially according to instant messaging in a multi-user environment. The plural client terminal apparatuses 12 are subscribers of the instant messaging.

The medical support server apparatus 11 is a medical support apparatus of the present invention, and in response to the request from the client terminal apparatus 12, generates and updates the medical support page 21, and performs information distribution of the medical support page 21 to the client terminal apparatus 12. A medical care information database 22 or medical care information DB is combined with the medical support server apparatus 11, and stores medical care information to be displayed in the information display area A2 of the medical support page 21.

Note that various letters and numbers are actually displayed in the medical support page 21 in FIG. 1. However, the letters and numbers are substantially the same as those displayed in the medical support page 21 in FIG. 9.

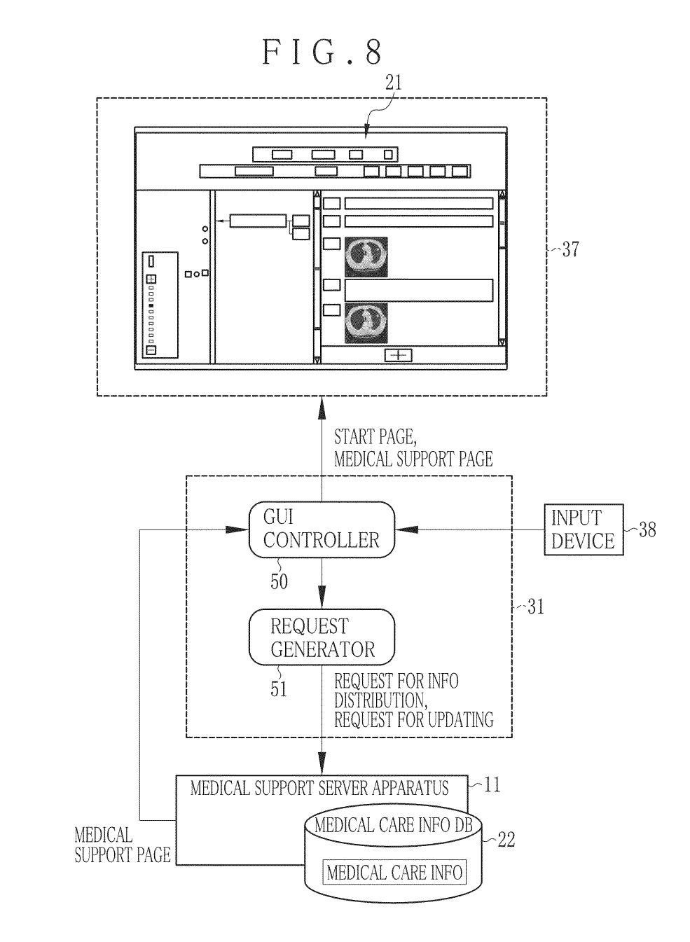

In FIG. 6, the medical care information includes message information from one staff member to another, and diagnostic information of examination (such as a CT image or diagnostic image). Meta information is combined with the medical care information, including a date and time (timestamp information) of entry and a message sender of the entry, and stored in a sequence of the entry. The medical care information is entered in the course of a progress of the medical care schedule displayed in the schedule area A1 in the medical support page 21. A schedule ID is allocated to the medical care information for recognition of a relevant one of the medical care schedules. The medical care information is stored in the medical care information database 22 with index information in a recognizable manner between the medical care schedules. In FIG. 6, the schedule ID of the medical care schedule is ABCDE, which means the medical care schedule for the patient body A in FIG. 5.

Note that examples of the medical care information being entered and stored are diagnostic images themselves. However, other examples of the medical care information can be address information, a link tag, a thumbnail image and the like. The address information is metadata of the diagnostic images for search and reference. The link tag is for the purpose of access to the diagnostic images. The thumbnail image is an image of a lowered resolution extracted from each diagnostic image. The address information, link tag, thumbnail image and the like correspond to the medical care information of the present invention.

Each one of the medical support server apparatus 11, the client terminal apparatus 12, the electronic chart server apparatus 15, the image server apparatus 16 and the scheduling server apparatus 17 is constituted by a computer and programs installed therein. Examples of the computer are a personal computer, server computer, workstation and the like. The programs include control programs and application programs. The control programs are an Operating System (OS) and the like. The application programs are client programs, server programs and the like.

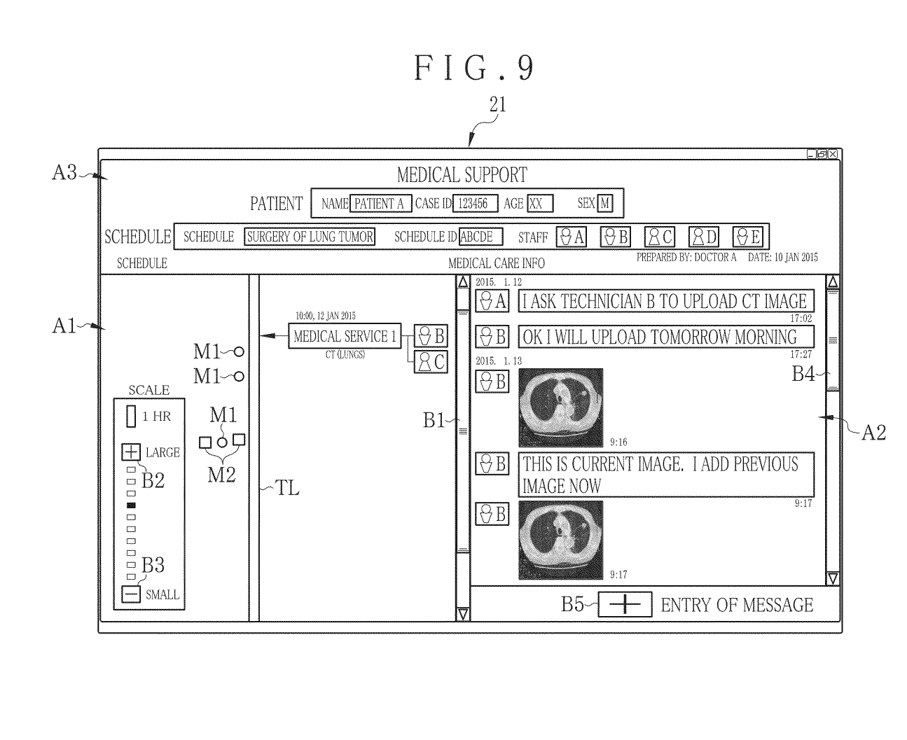

In FIG. 7, each of the medical support server apparatus 11, the server apparatuses 15-17 and the client terminal apparatus 12 is constituted by a computer in an equal manner. Each computer includes a CPU 31, a memory 32, a storage medium 33 or storage device, a communication interface 34 and a user interface 35 for an input/output. A data bus 36 interconnects those circuit devices. The user interface 35 includes a display panel 37 and an input device 38 such as a keyboard and mouse.

An example of the storage medium 33 is a hard disk drive or HDD. An application program 40 as a computer-executable program is stored in the non-transitory storage medium 33. Also, a disk array having plural HDDs is combined with each of the medical support server apparatus 11, the electronic chart server apparatus 15, the image server apparatus 16 and the scheduling server apparatus 17 by way of the storage medium 33 but separately from the HDD for the program. Note that the disk array can be contained in a server main unit of the server apparatus, but can be externally connected to the server main unit by use of the local area network or LAN as a network.

The non-transitory memory 32 is a working memory with which the CPU 31 performs tasks, for example, RAM (random access memory). The CPU 31 reads the control program from the storage medium 33, and loads the memory 32 with the control program, to control various elements in the computer by running the control program. The communication interface 34 is a network interface for controlling transmission by use of the network 14.

The client program as the application program 40 is installed in the client terminal apparatus 12. The client program is run in the client terminal apparatus 12 to perform access to the medical support server apparatus 11 for transmitting requests for viewing the medical support page 21 and updating the medical support page 21, and to receive and display the medical support page 21 from the medical support server apparatus 11 to the client terminal apparatus 12, in combination with instant messaging in the multi-user environment, where each client terminal apparatus 12 is a subscriber. Note that the client program may be programmed specially for the medical support system 10, or can be a web browser of a widely used type.

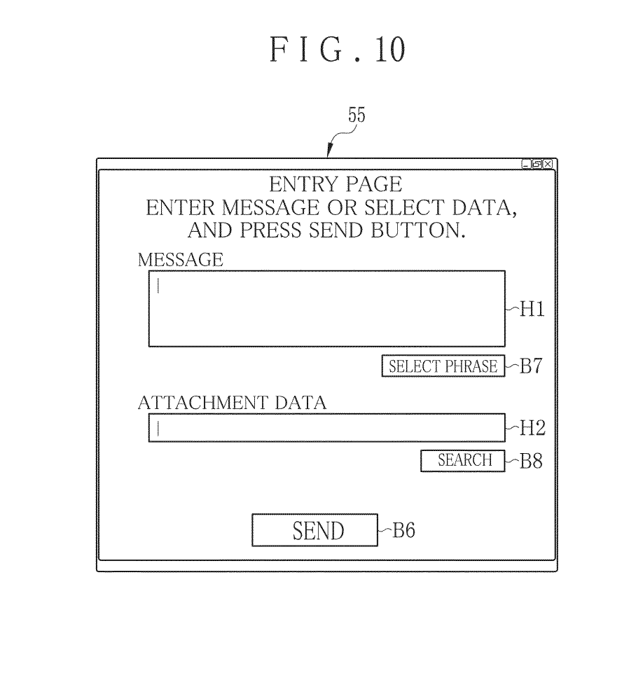

In FIG. 8, the display panel 37 in the client terminal apparatus 12 displays a start page with functions according to the GUI (graphical user interface). The CPU 31 in the client terminal apparatus 12 is caused by running the client program to function with a GUI controller 50 (scroll processor) and a request generator 51 or request generation unit, in cooperation with the memory 32. The request generator 51 generates various requests to the medical support server apparatus 11. In the start page, a case ID for the patient body is designated. A request for information distribution of the medical support page 21 is generated.

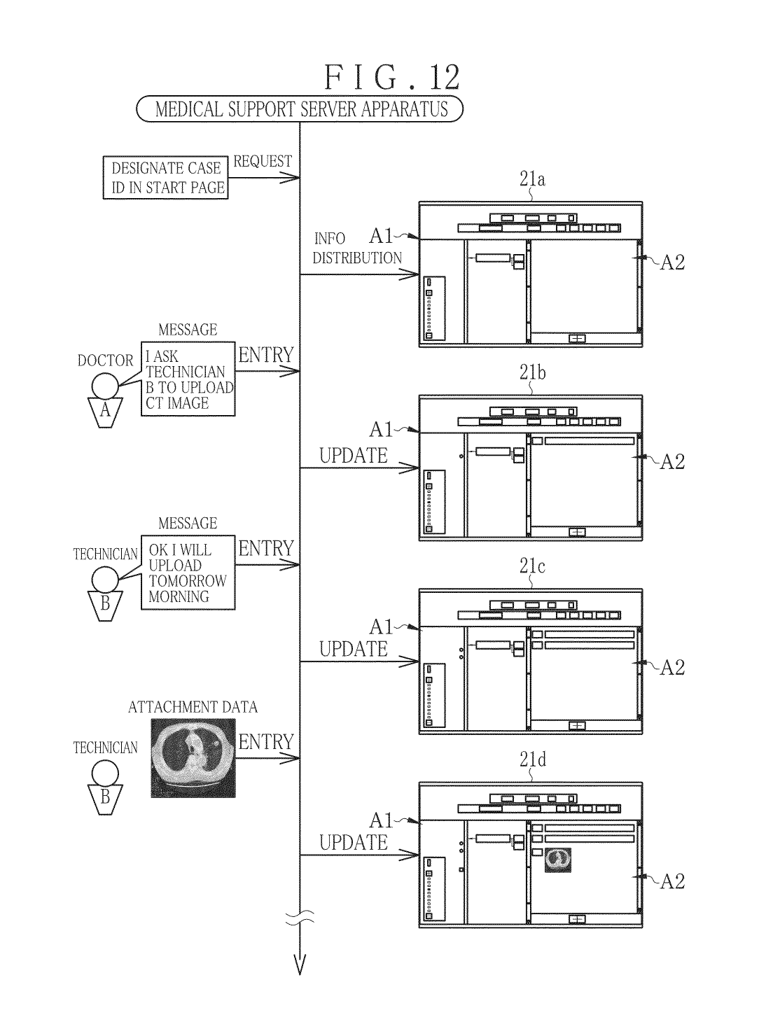

The medical support page 21 is constituted by data described in a markup language, for example, XML (Extensible Markup Language), and has functions for user input according to the GUI. The GUI controller 50 controls the screen view according to the received inputs from the input device 38 with the medical support page 21, such as manipulation of a keyboard or clicking of screen buttons with a pointer of a mouse. The GUI controller 50 inputs a command signal of a request to the request generator 51. The request generator 51 generates requests in response to the command signal from the GUI controller 50, for information distribution of an entry page 55 (See FIG. 10) or the medical support page 21 of the designated case ID, and for updating the designated information.

Note that various letters and numbers are actually displayed in the medical support page 21 in FIG. 8. However, the letters and numbers are substantially the same as those displayed in the medical support page 21 in FIG. 9.

In FIG. 9, the medical support page 21 includes a personal area A3 (case information area) in addition to the schedule area A1 and the information display area A2 described above. The personal area A3 displays the personal information, namely the patient's name, case ID, age and sex. Also, additional data are displayed in the personal area A3, including a schedule name of the medical care schedule displayed in the schedule area A1, schedule ID, user icon for the staff member, and the like.

Also, the schedule area A1 displays a first scroll button B1 (for an input action of scroll), an enlargement button B2, a reduction button B3 and indicators M1 and M2 in addition to the medical care schedule. The information display area A2 displays a second scroll button B4 (for an input action of scroll) and an entry button B5 (as a button portion) in addition to the medical care information.

The first scroll button B1 in the schedule area A1 is displayed for scrolling an active display area in the schedule area A1 in an upward direction to the past or a downward direction to the future. Upon shifting the first scroll button B1 up or down, a request for updating the active display area is generated and transmitted from the client terminal apparatus 12 to the medical support server apparatus 11. The medical support server apparatus 11 responsively updates and changes over the active display area for the schedule area A1, and supplies the client terminal apparatus 12 with the updated medical support page. The active display area of the medical care schedule is changed over in the client terminal apparatus 12. In FIG. 9, an active display area A5 for a medical care schedule of FIG. 5 is a partial schedule window in the schedule area A1, and illustrated with the broken line.

The enlargement button B2 and the reduction button B3 are for enlarging or reducing the display size of the medical care schedule for display in the schedule area A1. Operating one of the enlargement button B2 and the reduction button B3 generates a request for updating to change over the display size. The client terminal apparatus 12 transmits the request to the medical support server apparatus 11. The medical support server apparatus 11 according to the request updates the schedule area A1 to change over the display size, and transmits the updated medical support page to the client terminal apparatus 12. Thus, the display size of the medical care schedule is changed over in the client terminal apparatus 12. In short, the medical care schedule in the schedule area A1 (or the timeline TL) is changeable in the display size (scale).

The indicators M1 and M2 indicate a date or time (timestamp information) of receiving (entry of) the medical care information. It is possible with the medical support page 21 to post new medical care information by operating the entry button B5 displayed in the information display area A2. Entering the medical care information generates a request for updating to display the indicator M1 or M2, so that the request is transmitted from the client terminal apparatus 12 to the medical support server apparatus 11. The medical support server apparatus 11 in response to the request updates the indicator M1 or M2 in the schedule area A1, to update the medical support page 21 by transmitting the updated medical support page to the client terminal apparatus 12.

Specifically, assuming that the entered medical care information is message information such as a comment, the medical support server apparatus 11 updates the medical support page 21 to display the indicator M1 of the circular form at a location corresponding to time of entering the medical care information along a timeline representation TL. Also, assuming that the entered medical care information is a diagnostic result such as a diagnostic image, the medical support server apparatus 11 updates the medical support page 21 to display the indicator M2 of the quadrilateral form at a location corresponding to time of entering the medical care information along the timeline representation TL. Then the updated medical support page is output by information distribution to the client terminal apparatus 12. The schedule area A1 displays an indicator of the form according to the type of the entered medical care information. In the present embodiment, the indicators M1 and M2 are arranged in the number equal to the number of the entered items of the medical care information at a location of the timeline representation TL should the plural items of the medical care information be entered simultaneously.

The second scroll button B4 in the information display area A2 is disposed to scroll the active display area in the schedule area A1 in an upward direction to the past or in a downward direction to the future. Upward or downward slide of the second scroll button B4 generates a request for updating the active display area, so that the client terminal apparatus 12 transmits the request to the medical support server apparatus 11. The medical support server apparatus 11 in response to the request updates the active display area in relation to the information display area A2, and performs information distribution of the updated medical support page to the client terminal apparatus 12. Thus, the active display area is changed over in the client terminal apparatus 12. In FIG. 9, an active display area A6 for medical care information indicated by the broken line is a partial information window to display the medical care information in the information display area A2.

The entry button B5 is used for newly entering medical care information by instant messaging. Operation of the entry button B5 generates a request for information distribution of the entry page 55 in which new entry is received, in FIG. 10. The client terminal apparatus 12 transmits the request to the medical support server apparatus 11. The medical support server apparatus 11 transmits the entry page 55 to the client terminal apparatus 12 in response to the request. Thus, the client terminal apparatus 12 displays the entry page 55.

In FIG. 10, the entry page 55 includes a message field H1 for message information, a data attachment field H2 for medical care information (input fields), and a send button B6. The message field H1 is used for directly inputting a message text (comment) by a user or doctor operating a keyboard or other input device at the client terminal apparatus 12. Also, there is a phrase selection button B7 in the entry page 55, for displaying predetermined phrases as selection options. He or she can input a selected one of the phrases from the phrase selection button B7 into the message field H1.

The data attachment field H2 is used to designate attachment data to be entered. An address of storing the attachment data is input to the data attachment field H2 to designate the attachment data. A case ID or the like is input as a search query in a search window after operating a reference button B8, so that it is possible to designate attachment data for entry from various data in the entire system in connection with the network 14, for example, from among diagnostic images stored in the image database 19.

In case the send button B6 is operated after inputting data to at least one of the message field H1 and the data attachment field H2, the input information is transmitted by the client terminal apparatus 12 to the medical support server apparatus 11 as medical care information. The medical support server apparatus 11 receives the medical care information and stores the same in the medical care information database 22 in a sequence of the reception. The medical support page 21 is updated by generation of the request upon storing (entering) the new medical care information, to display the indicator M1 or M2 in the schedule area A1.

Also, the operation of the send button B6 causes the client terminal apparatus 12 to transmit a request to the medical support server apparatus 11 for updating the information in the information display area A2 according to the input medical care information. The medical support server apparatus 11 in response to the request updates the information display area A2 to display the newly received medical care information at a location directly under the recent medical care information having been stored. The medical support server apparatus 11 performs information distribution of the updated medical support page to the client terminal apparatus 12. Thus, the newly received medical care information is displayed in the information display area A2 together with the recent medical care information.

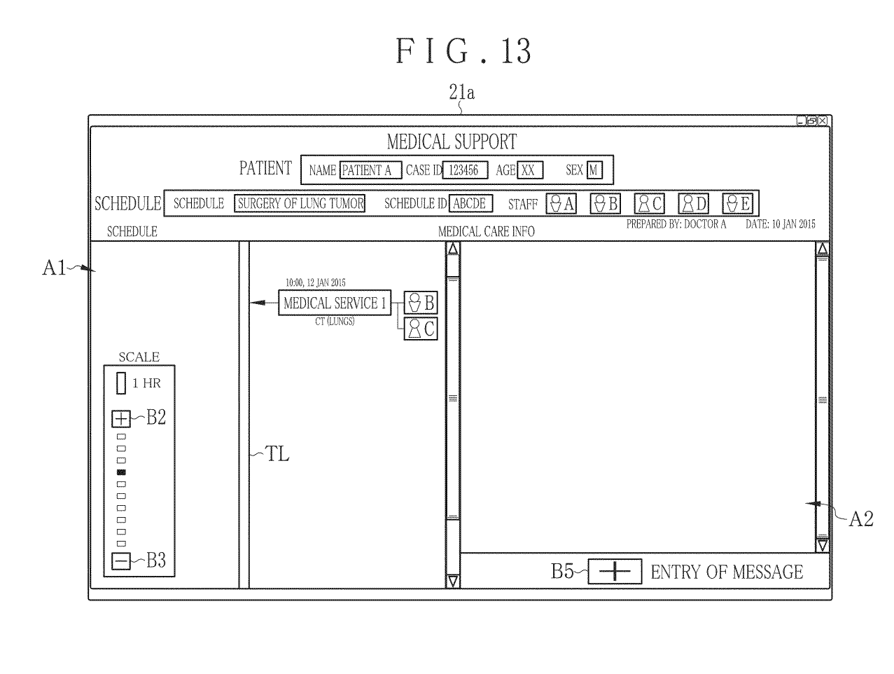

In FIG. 11, the server program is installed in the medical support server apparatus 11 by way of the application program 40. The CPU 31 in the medical support server apparatus 11 is caused by running the server program to cooperate with the memory 32, to function the input receiving device 60, an information updating unit 61 for medical care information, a page generator 62 (uploader) or display processor, and an output transmission device 63 or output control device.

The input receiving device 60 receives the medical care information from the entry page 55 of the client terminal apparatus 12, and transfers the medical care information to the information updating unit 61, the medical care information having been entered from the client terminal apparatus 12 by user input of a doctor or staff member. The information updating unit 61 stores the medical care information in the medical care information database 22 in a sequence of entry by use of the entry page 55, namely sequence of inputting and receiving at the input receiving device 60. See FIG. 6.

Also, the input receiving device 60 receives requests from the client terminal apparatus 12, and inputs the requests to the page generator 62, the requests including one for information distribution of the medical support page 21 or the entry page 55, and one for updating the medical support page 21.

The page generator 62 in response to a request for information distribution of the medical support page 21 acquires a medical care schedule from the schedule database 20 according to the case ID designated by the request. Also, the page generator 62 in response to the designated case ID acquires medical care information from the medical care information database 22 according to the designated medical care schedule. The page generator 62 generates the medical support page 21 containing the schedule area A1 and the information display area A2 in FIG. 9, and sets the medical support page 21 in the output transmission device 63, the schedule area A1 displaying the acquired medical care schedule, the information display area A2 displaying the acquired medical care information in a sequence of reception or entry.

The page generator 62 in response to a request for information distribution of the entry page 55 generates the entry page 55 and sets this in the output transmission device 63. Also, the page generator 62 in response to a request for updating the medical support page 21 updates the medical support page 21 according to various command signals in the request, such as signals from the first and second scroll buttons B1 and B4, the enlargement button B2 and the reduction button B3. The medical support page 21 being updated is set in the output transmission device 63.

The output transmission device 63 performs information distribution of the medical support page 21 and the entry page 55 from the page generator 62 to the client terminal apparatus 12 as a requester. The client terminal apparatus 12 drives the display panel 37 to display the medical support page 21.

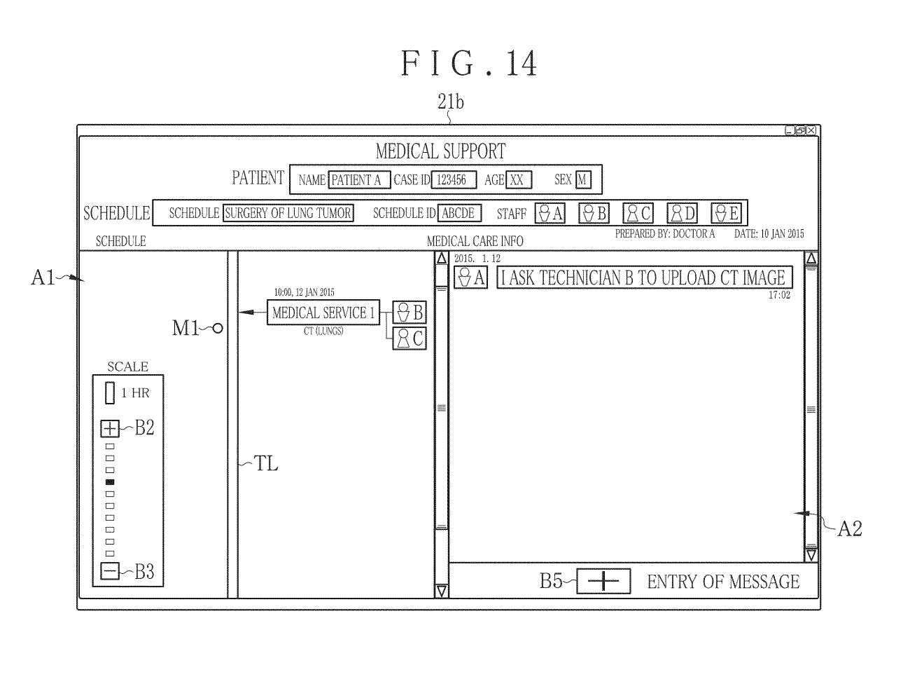

The operation of the above construction is described now by referring to FIGS. 12-16. To display a medical support page, the client program is run in the client terminal apparatus 12. A case ID for a patient body is designated. The client terminal apparatus 12 generates a request for information distribution of the medical support page, and inputs the request to the medical support server apparatus 11.

Upon receiving the request, the medical support server apparatus 11 acquires the medical care schedule from the schedule database 20 in relation to the case ID designated in the request, and acquires medical care information from the medical care information database 22 in combination with the medical care schedule according to the case ID. The medical support server apparatus 11 creates the medical support page 21 containing the schedule area A1 for the medical care schedule and the information display area A2 for the medical care information, and performs information distribution of the medical support page 21 to the plural client terminal apparatuses 12 of the medical team, namely subscribers.

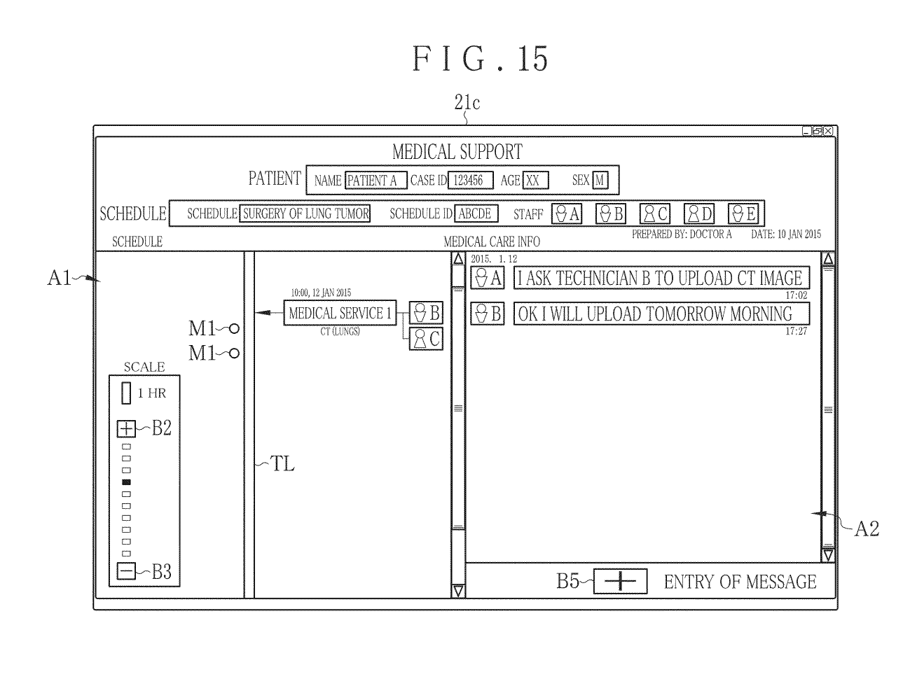

In FIG. 13, assuming that the medical care information database 22 does not store medical care information, then a medical support page 21a is output by information distribution to the client terminal apparatus 12, the medical support page 21a not displaying the medical care information in the information display area A2 and not displaying the indicator M1 or M2 in the schedule area A1. The entry page 55 in FIG. 10, after information distribution to the client terminal apparatus 12 by operating the entry button B5 in the medical support page 21a, makes it possible to enter message information or to enter new medical care information by selecting attachment data, such as a text of the message information or a data file of a diagnostic image. Then the medical support page 21a is updated according to the entered medical care information.

In FIG. 12, the doctor A enters message information to the technician B, for example, “I ask Technician B to upload CT image”. Then the medical support page 21a is changed over to a medical support page 21b by updating. In FIG. 14, the information display area A2 in the medical support page 21b displays a user icon, the message information, date or time (timestamp information) of entry and the like, the user icon expressing the doctor A as a message sender of the message information. The indicator M1 of the circular shape is displayed in the schedule area A1 in the medical support page 21b for indicating the entered message information together with the timeline TL.

In FIG. 12, the technician B (radiologist) upon viewing the medical support page 21b enters message information of “OK I will upload tomorrow morning”. Then the medical support page 21b is changed over to a medical support page 21c by updating. In FIG. 15, the information display area A2 in the medical support page 21c displays a user icon, the message information, date or time of the entry and the like, the user icon expressing the technician B as a message sender of the message information. The indicator M1 of the circular shape is displayed in the schedule area A1 in the medical support page 21c for indicating the entered message information together with the timeline TL.

In FIG. 12, attachment data for a diagnostic result (diagnostic images) is entered with the medical support page 21c according to a request from the doctor A to the technician B. Then the medical support page 21c is updated to obtain a medical support page 21d. In FIG. 16, the information display area A2 in the medical support page 21d displays the user icon, the attachment data, date or time of the entry and the like, the user icon expressing the technician B as a sender of the attachment data. The indicator M2 of the quadrilateral shape is displayed in the schedule area A1 in the medical support page 21d for indicating the entered attachment data together with the timeline TL.

Note that various letters and numbers are actually displayed in the medical support pages 21a, 21b, 21c and 21d in FIG. 12. However, the letters and numbers are substantially the same as those displayed in FIGS. 13-16.

In conclusion, the medical support page 21 including the information display area A2 and the schedule area A1 is displayed according to the medical support system 10 of the present embodiment, the information display area A2 displaying the medical care information after the user input in the medical team by following the sequence of the entry, the schedule area A1 displaying the medical care schedule. Accordingly, the medical support can be performed more easily with adequate content information in comparison with known techniques for medical support.

In the medical support system 10 of the embodiment, the date or time of the entry of the medical care information can be easily recognized as the indicators M1 and M2 are displayed with the timeline TL for indicating the entry of the medical care information. Also, a display form (shape) of the indicators is changed according to a type of the entered medical care information, to facilitate the recognition of the type of the medical care information. Furthermore, the number of the indicators is set equal to the number of the items of the medical care information entered at the same time, to facilitate the recognition of the number of the information items. A display size of the medical care schedule in the schedule area A1 can be changed according to preference of a user.

The invention is not limited to the embodiment. Although the first scroll button B1 is used for an input action of scrolling the active display area of the medical care schedule in the schedule area A1, other input devices or input actions can be used to scroll the schedule area A1. Examples of the input actions are rotation of a roller in a mouse, depression of an up/down button of a keyboard, dragging and dropping of a cursor for the schedule area A1, and the like.

To this end, the page generator 62 updates the medical support page 21 to change over an active display area of the schedule area A1 in response to the rotation of the roller in the mouse, depression of the up/down button of the keyboard, dragging and dropping of the cursor for the schedule area A1, and the like. Also, it is possible to set an active display area of the information display area A2 scrollable in response to the rotation of the roller in the mouse, depression of the up/down button of the keyboard, dragging and dropping of the cursor for the information display area A2, and the like.

Also, it is possible to set the information display area A2 scrollable in response to scrolling the schedule area A1. For example, the medical care information entered at the time corresponding to the beginning of the schedule area A1 can be preferably disposed at the beginning of the information display area A2, in order to scroll the information display area A2 in response to scrolling the schedule area A1 by updating the medical support page 21 with the page generator 62. Furthermore, it is possible to set the schedule area A1 scrollable in response to scrolling the information display area A2.

Also, it is possible to set the information display area A2 scrollable in response to an input action to the schedule area A1. For example, the medical care information corresponding to one of the indicators M1 and M2 being clicked in the schedule area A1 can be preferably disposed at the beginning of the information display area A2, in order to scroll the information display area A2 by updating the medical support page 21 with the page generator 62. Furthermore, it is possible to set the schedule area A1 scrollable in response to an input action to the information display area A2.

In the embodiment, the indicator M1 of the circular shape is displayed for the message information as the entered medical care information. The indicator M2 of the quadrilateral shape is displayed for the attachment data (patient health information) as the entered medical care information. A display form of the indicators is changed over according to the type of the entered medical care information. However, the indicators can be changed over according to other criteria. Examples of the criteria are message types of the message information, such as instruction, request, confirmation, question and the like, and plural ranks of importance of the message information. To this end, meta information for the message information in relation to the criteria is input from the entry page 55. It is possible to change over the indicators according to the message types or the ranks of importance of the message information in consideration of the input meta information. Also, the indicators can be changed over according to the attributes or importance of the attachment data (as patient health information), or can be changed over according to attributes or importance of partial medical care information which is different from the message information and attachment data but is included in the medical care information.

In the above embodiment, the indicators are quadrilateral and circular. However, the indicators are not limited thereto. Display forms of the indicators can be triangular, pentagonal, rhombic, star-formed and the like. The display form of the indicators can be changed according to the entered medical care information. Also, a display size of the indicators can be changed as a display form. Furthermore, an example of display form of the indicators can be color. For example, a red indicator can be displayed for the medical care information of high importance. A white indicator can be displayed for the medical care information of low importance. A form of turning on the indicators can be changed, for example, use of winking of the indicators, and a time interval of the winking.

In the above embodiment, the number of the displayed indicators is set equal to the number of the entered items of the medical care information in response to entering the plural items of the medical care information in a simultaneous manner. However, it is possible to set a display form of the indicators in a changeable manner according to the number of the entered items of the medical care information. For example, a size of the indicators can be increased according to an increase in the number of the entered items of the medical care information.

In the above embodiment, indicators for earlier and later medical care information than a time zone of the active display area in the medical care schedule are not displayed in the schedule area A1. However, it is possible to display indicators in the schedule area A1 for earlier or later medical care information than the time zone of the active display area in the medical care schedule.

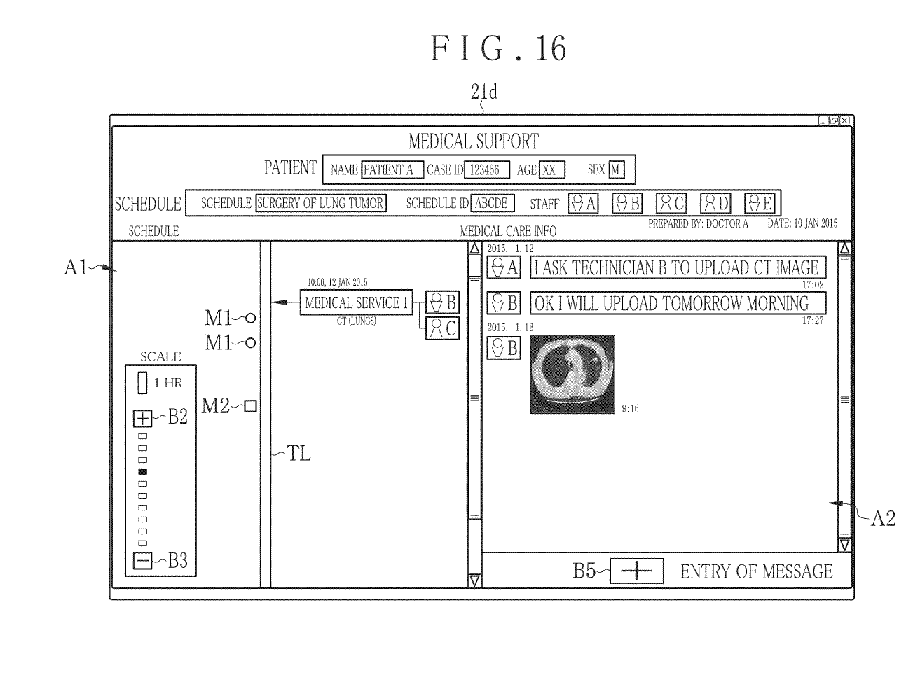

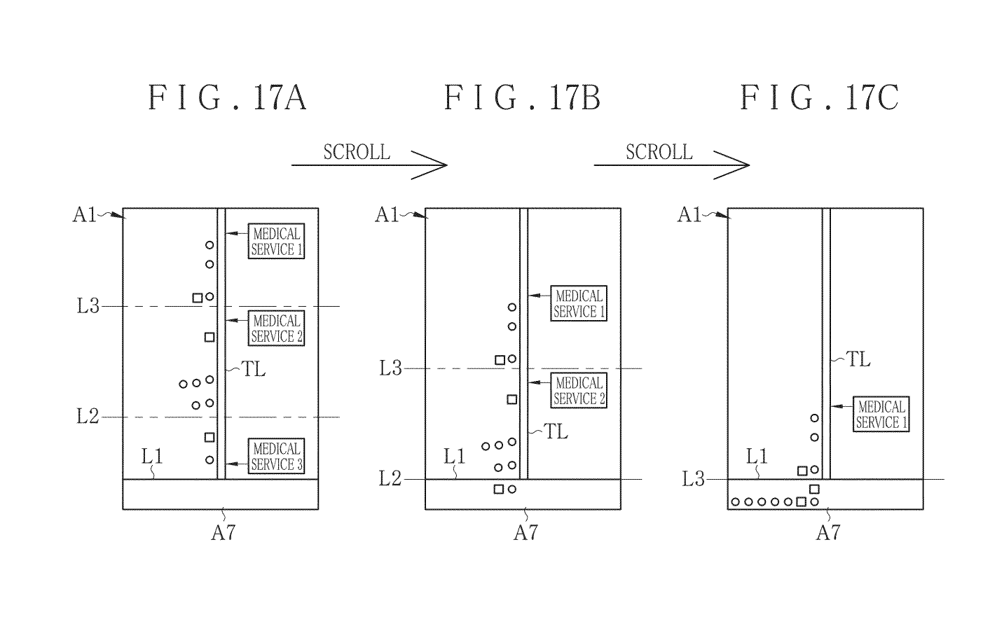

In FIG. 17A, an indicator area A7 is disposed in the schedule area A1 under a lower limit line L1 for indicating a lower limit of an active display area of the medical care schedule. The indicator area A7 displays an indicator corresponding to medical care information entered later than a time point of the lower limit line L1. Assuming that there is medical care information entered after the time point of the lower limit line L1, an indicator of a display form according to the medical care information is displayed. In FIG. 17A, no indicator is displayed in the indicator area A7. This means that there is no medical care information entered after the time point of the lower limit line L1.

In case the medical support page is scrolled down to align a virtual line L2 with the lower limit line L1 in FIG. 17A, two indicators are additionally displayed in the indicator area A7 after exclusion from the screen view by the scroll, the two indicators including indicators of one circle and the one quadrilateral. See FIG. 17B. Note that indicators outside the active display area are displayed in a sequence of the exclusion from the active display area from a center position to an end position of the indicator area A7 with reference to the timeline TL.

In case the medical support page is scrolled down to align a virtual line L3 with the lower limit line L1 in FIG. 17B, six indicators are additionally displayed in the indicator area A7 after exclusion from the screen view by the scroll, the six indicators including indicators of five circles and one quadrilateral. See FIG. 17C. Note that the indicator area A7 is so constructed to display two arrays of seven indicators, namely 14 indicators. Assuming that an eighth or subsequent indicator is required in the indicator area A7, the seven presently displayed indicators are shifted down by one array, and the eighth or subsequent indicator becomes displayed in a second array serially from the center position.

In the embodiment, the indicator area is disposed for the indicators according to the medical care information entered after the time point of the lower limit line for the lower limit of the active display area. Thus, the number of the items of the medical care information entered after the time point of the lower limit line can be easily recognized. Furthermore, it is possible to dispose an indicator area for indicators according to medical care information entered before a time point of an upper limit line for an upper limit of the active display area.

Also, a display area for displaying a medical service before or after the time zone of the active display area can be disposed among the medical services constituting the medical care schedule. The medical service before or after the time zone of the active display area can be displayed in the display area. Should a name of the medical service or the like be displayed in the display area, the number of the medical services displayable in the display area will be low, or a size of the display area will be too large. It is preferable to use an icon or symbol of the medical service for indicating information of the medical service in the display area.

In the above embodiment, the medical care information is entered with the entry page 55. However, the medical care information can be input to the information display area A2 directly without use of the entry page 55. The input medical care information can be entered itself.

In the above embodiment, the entry page 55 is displayed in a large size. However, the invention is not limited to this structure. For example, it is possible to display the entry page 55 in a pop-up form while the medical support page is displayed.

Furthermore, the entry page 55 can be included in the medical support page. Specifically, the input fields H1 and H2 can be disposed in a lower portion of the medical support page. It is possible to scroll the medical support page to display the input fields H1 and H2, so that a user can easily enter his or her message information. Consequently, information distribution of the single page from the medical support server apparatus 11 can be performed at a high speed. Also, the entry button B5 can be unnecessary.

In the above embodiment, the displayed information is unchanged even in case the display size of the schedule area A1 is changed. However, the present invention is not limited to the embodiment. For example, enlargement of the display size decreases the number of the medical services displayed in the entirety of the medical care schedule, but increases an interval between the medical services arranged adjacently. It is possible to display the medical services in a more detailed manner upon enlarging the display size. For example, only names of the medical services can be displayed before the enlargement, but staff members, date and time and the like of the medical services can become displayed additionally after the enlargement. Furthermore, it is possible to display the medical services in a more simplified manner upon reducing the display size. For example, the names of the medical services can be displayed before the reduction, but only icons of the medical services can become displayed after the reduction.

In the embodiment, the information display area (medical care information area) is arranged next to the schedule area in the medical support page. However, the invention is not limited thereto. The schedule area and the information display area can be arranged together with one another. The medical care information can be displayed in association with the timeline of the schedule area. In short, the schedule area and the information display area can be so arranged that a first one of the areas contain a second one thereof, or that the areas are partially overlapped with one another.

Note that the system in the above embodiment is a client-server system in which the medical support page 21 is transmitted from the medical support server apparatus 11 to the client terminal apparatus 12 with the network 14. The medical support server apparatus 11 corresponds to the medical support apparatus. Furthermore, it is possible to construct the client terminal apparatus 12 as a medical support apparatus in place of the client-server system. For this purpose, the CPU 31 in the client terminal apparatus 12 is operated as the input receiving device 60, the information updating unit 61, the page generator 62 and the output transmission device 63. The input receiving device 60 receives the medical care information and requests from the input device 38 of the client terminal apparatus 12. The output transmission device 63 outputs the medical support page 21 from the page generator 62 to the display panel 37. In short, in the client-server system, the output transmission device 63 controls an output from the medical support server apparatus 11 to the client terminal apparatus 12. However, in the use of the client terminal apparatus 12 for the medical support apparatus, the output transmission device 63 controls an output to the display panel 37.

In the above embodiments, the timeline representation is an axial bar portion having a predetermined width and extending vertically. However, the timeline representation of the invention is not limited. For example, a timeline representation can be a timeline having an axis line and scale graduations arranged on the axis line, a series of dots, a series of numerals, and also a timeline representation having horizontally extending thin straight lines arranged in parallel with one another at a predetermined interval, to express time ranges by splitting areas in the vertical direction.

In the description heretofore, medical care or medical service includes diagnosis (questionnaire, work-up and/or examination) and treatment. Although the medical support apparatus is constructed for medical use, it is possible to known techniques of a workflow system or an instant messaging system (bulletin board system) for general use in the multi-user environment, in combination with the feature of the present invention.

The present invention is not limited to the above embodiments. Various features of the embodiments and variants of the invention can be combined with each other suitably. Also, the computer-executable program and a storage medium for storing the computer-executable program are included in the scope of the present invention.

According to one embodiment mode of the invention, a non-transitory computer readable medium for storing a computer-executable program is provided, the computer-executable program enabling execution of computer instructions to perform operations for medical support for outputting information of a medical service for a patient body. The operations include receiving medical care information input by user input in relation to the patient body. The operations include generating a medical support page containing first and second display areas arranged with one another, the first display area displaying a medical care schedule with plural medical services arranged in a time sequence to be performed for the patient body, the second display area displaying and arranging the medical care information in a sequence of reception while the medical services are performed.

Also, a user interface for medical support for outputting information of a medical service for a patient body is provided, and includes a first display area, disposed in a medical support page, for displaying a medical care schedule with plural medical services arranged in a time sequence to be performed for the patient body. A second display area is arranged with the first display area in the medical support page, for displaying and arranging the medical care information input by user input in relation to the patient body in a sequence of reception while the medical services are performed.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. A medical support apparatus for outputting information of a medical service for a patient body, comprising:
an input receiving device for receiving medical care information input by user input in relation to said patient body;
a page generator for generating a medical support page containing first and second display areas arranged with one another, said first display area displaying a medical care schedule with plural medical services arranged in a time sequence to be performed for said patient body, said second display area displaying and arranging said medical care information in a sequence of reception in said input receiving device while said medical services are performed.

2. A medical support apparatus as defined in claim 1, wherein said medical care information includes message information for communication between medical staff members.

3. A medical support apparatus as defined in claim 1, wherein said medical care information includes a diagnostic result of said patient body.

4. A medical support apparatus as defined in claim 1, wherein said first display area displays a timeline representation, and an indicator, disposed with said timeline representation, for indicating a date or time of receiving said medical care information.

5. A medical support apparatus as defined in claim 4, wherein a display form of said indicator is changeable according to a type of said medical care information.

6. A medical support apparatus as defined in claim 4, wherein upon receiving plural items of said medical care information at one time, said indicator of which a number corresponds to a number of said items of said medical care information is displayed.

7. A medical support apparatus as defined in claim 1, wherein said first display area displays a timeline representation with a changeable display size.

8. A medical support apparatus as defined in claim 4, wherein said medical care information includes patient health information and message information, said indicator is constituted by first and second indicators, said first indicator is set for said patient health information, and said second indicator is set for said message information and different from said patient health information in a display form.

9. A medical support apparatus as defined in claim 1, wherein in case a predetermined input action for scroll is performed, said medical care schedule in said first display area is scrolled in a direction of said time sequence in said medical support page.

10. A medical support apparatus as defined in claim 1, wherein in case a predetermined input action for scroll is performed, said medical care information in said second display area is scrolled in a direction of said sequence of said reception in said medical support page.

11. A medical support apparatus as defined in claim 1, wherein said page generator further performs display processing of:
an input field adapted to input said medical care information by user input; and
a send button portion, operated by user input, for sending said medical care information input in said input field.

12. A medical support apparatus as defined in claim 4, wherein said medical care schedule is scrollable in said medical support page, and partially displayed in said first display area;
said plural medical services include first and second medical services, said first medical service and said indicator thereof are displayed in said first display area, and said second medical service is excluded from said first display area and undisplayed;
said page generator further performs display processing of an indicator area, displayed along an edge of said first display area, for displaying a second indicator associated with said second medical service.

13. A medical support system including a client terminal apparatus, and a medical support apparatus for outputting information of a medical service for a patient body according to a request input by said client terminal apparatus, said medical support system comprising:
said medical support apparatus including:
an input receiving device for receiving medical care information input by user input in relation to said patient body;
a page generator for generating a medical support page containing first and second display areas arranged with one another, said first display area displaying a medical care schedule with plural medical services arranged in a time sequence to be performed for said patient body, said second display area displaying and arranging said medical care information in a sequence of reception in said input receiving device while said medical services are performed.

14. A medical support system as defined in claim 13, wherein said input receiving device receives said medical care information from said client terminal apparatus, and said page generator outputs said medical support page to said client terminal apparatus.

15. A medical support method for outputting information of a medical service for a patient body, comprising steps of:
receiving medical care information input by user input in relation to said patient body;
generating a medical support page containing first and second display areas arranged with one another, said first display area displaying a medical care schedule with plural medical services arranged in a time sequence to be performed for said patient body, said second display area displaying and arranging said medical care information in a sequence of reception while said medical services are performed.
